(19) United States
(12) Patent Application Publication
(10) Pub. No.: US 2010/0265283 A1
(43) Pub. Date: Oct. 21, 2010

(54) OPTIMAL SPATIAL DISTRIBUTION FOR MULTIPRIMARY DISPLAY

(75) Inventors: Erno Hermanus Antonius Langendijk, Eindhoven (NL); Michiel Adriaanszoon Klompenhouwer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/741,045

(22) PCT Filed: Nov. 4, 2008
(86) PCT No.: PCT/IB2008/054581

§ 371 Date: May 3, 2010

(30) Foreign Application Priority Data
Nov. 6, 2007 (EP) 07120061.2
Oct. 31, 2008 (IB) PCT IB2008 054532

(51) Int. Cl. G09G 5/02

(52) U.S. Cl. 345/694

(57) ABSTRACT

To have a good resolution/sharpness for the displayed pictures (e.g. low interference banding in case of showing a pattern having Nyquist limit problems), the multiprimary display (100), has more than 3 additive primaries (R,C,G,B), in which that half of the primaries (C,G) having the highest output luminances of the more than 3 additive primaries (R,C,G,B) when a corresponding driving signal (r) for the respective primary is maximal, is generatable by subpixels (104, 108) of the display at approximately equidistant subpixel positions (Dd).

### FIELD OF THE INVENTION

The invention relates to a multiprimary display, which is known as a display with more than the classical 3 additive primaries red, green and blue (e.g. by supplementing a yellow fourth primary), and a method for appropriately driving such a display given an input color to be reproduced.

### BACKGROUND OF THE INVENTION

The last decennium there is a grown interest in constructing multiprimary displays.

Displays have advanced majorly since their conception around the end of the 19^{th} century, but they still cannot reliably render real scenes, so there is still a drive towards further improvement. E.g., the geometry of most scenes (size, 3D appearance, . . . ) cannot be accurately rendered on current displays (not the home television or movie theatre displays, let alone a small display of e.g. a portable phone, or laptop computer for outside movie viewing), but rather a schematic appearance which the mind can understand and accept is rendered. Similarly, there are many problems relating to color rendering of a reproduction of a scene are still present (e.g. the grey value dynamic range is too low, dark regions cannot be rendered faithfully, . . . ).

As to the chromaticities of natural colors, because a three primary additive color display can only render those chromaticities within the triangular gamut defined by those three primaries, and real world colors are partially subtractive, falling out of this gamut, recently displays have emerged with extra primaries, mostly inspired on subtractive color theory, such as e.g. an additional yellow, magenta, cyan, or purplish blue, or orange.

These displays being relatively new however, it is still a problem to be able to construct them so that reliably and simply the classical picture quality objectives can be achieved, such as e.g.: no chromatic errors, and in particular good picture resolution. So if a good design was conceived for e.g. saturated color rendering with high luminance, there may be room for improvement picture resolution/sharpness-wise.

### SUMMARY OF THE INVENTION

Having such objectives in mind, elements of the present invented technologies comprise:

A multiprimary display (100), having more than 3 additive primaries (R,C,G,B), in which that half of the primaries (C,G) having the highest output luminances of the more than 3 additive primaries (R,C,G,B) when a corresponding driving signal (r) for the respective primary is maximal, is generatable by subpixels (104, 108) of the display at approximately equidistant subpixel positions (Dd).

The skilled person should understand the wording half in a pragmatic manner. If the number of primaries is uneven—e.g. 5—the half of the total set of primaries having the highest luminance may comprise 2 or 3 primaries (not 1, 4, or 5), and the rest of the primaries —which one can call the half with lower luminance—are then the three others.

First one defines (typically before applying the present invention, although one could apply the both in a co-optimized single process) a set of primaries from the desires of the market: e.g. in addition to the classical primaries red, green and blue necessary for spanning a large part of all possible chromaticities—these may for a multiprimary display be chosen different from those of e.g. EBU or NTSC televisions—one adds a yellow to be able to render lemons, a cyan for certain paints, and a magenta for some woman's dresses, or a second red primary, which may or may not be different in chromaticity (and typically output spectrum) from the first red primary.

Having defined those primaries, the current invention distributes them in a smart way over the successive display subpixels, e.g. in FIG. 1 they are constructed on the display in linear horizontal order, after 6 subpixels, the pattern beginning again.

It can be understood that by dividing the set in two halves, on has approximately the same number of primaries in both halves. The manufacturer may do this by driving a built display to maximal drive value (e.g. generating a drive value of 255 for the green channel) and measuring with e.g. a colorimeter the luminance. In practice however before actually constructing a (small demo) display panel, he will mathematically model it (the backlight, filters, . . . ), and for the example of figure one find e.g.:

the yellow has the highest luminance, then the cyan, then the green, then the first red R, etc.

Since for 6 primaries, the set/half of the high luminance primaries would contain three primaries, we put those three with the highest luminance in that half (i.e. cyan, green, and yellow), the two reds and the blue then constituting the dark, low luminance half set of primaries.

The skilled person now understands that there is for approximately each bright, high luminance primary a dark primary choosable (at least when the number of primaries is even that is exactly true, for uneven numbers there is one primary—which one may arbitrarily classify as bright or dark, which cannot have an allocated partner), so he understands that “approximately equidistant subpixel positions” means that the manufacturer tries to divide those high luminance primaries over the grid at equal distances (e.g. for 6 primaries distances Dd equal to 2/6^{th} of the width of a pixel, composed of the 6 subpixels), which would be possible for an even number of primaries, since one can then interlace high primary luminance subpixels with low primary luminance subpixels (i.e. always 1 high luminance primary, one low luminance primary, one high luminance primary, etc., until all subpixels in a row of the display have been allocated a primary), however for an uneven number of primaries he needs to optimize so that most of the primaries on adjacent subpixels alternate from bright to dark, but there will be one neighbor which is from the same half.

Also the skilled person understands that a “primary is generatable by a display subpixel” means that the physical construction of the underlying display according to known and existing principles is meant, e.g. for a plasma display, one makes the underlying cell glow a certain amount under order of the driving value, and the phosphor converts the generated light in a local amount of colored light, of e.g. the red primary spectrum. Once he learns from the here present teaching how the different primary colors should be ordered spatially, he knows how—in his precise fabrication process—how to make this cells on the panel.

This principle has experimentally shown to give very good image resolution.

One should understand that fulfilling this principle one can still vary further, e.g. look at the luminance modulation of the successive high frequency primaries (this being interesting if there are e.g. 8 primaries) and choose for a low frequency pattern (i.e. one orders them in a succession of decreasing luminance: yellow, cyan , green, . . . ) or vice versa choosing for a high frequency pattern, e.g. more or less sampling the primaries in the bright half randomly, before allocating them to the interleaved successive subpixel positions.

Also one can allocate the dark neighbors of the bright primaries corresponding to the luminance of the respective bright primaries, e.g. in the decreasing luminance order (1^{st} brightest, second brightest, . . . ) choose from the dark half also the decreasing-luminance ordered primaries (1^{st} brightest of the dark set being the first red, second brightest being the second red, . . . ), or vice versa allocating the darkest luminance primary adjacent to the brightest etc., i.e. in reverse order.

### BRIEF DESCRIPTION OF THE DRAWINGS

These and other aspects of the invention will be further elucidated and described with reference to the drawing, in which:

FIG. 1 schematically shows an exemplary embodiment of a multiprimary display with optimized adjacent subpixel colors according to the principles invented and presently described, from which the skilled person would find it possible to apply those principles to other possible multiprimary display types.

FIG. 2 shows another optimal subpixel distribution, in particular useful for longitudinal pixels (e.g. ⅓).

FIG. 3 shows another such distribution, which generically illustrates the possibility of interchanging similar colors (here red and magenta, being relatively similar in brightness and chromaticity).

FIG. 4 shows a two-dimensional tiling example.

### DETAILED DESCRIPTION OF EMBODIMENTS

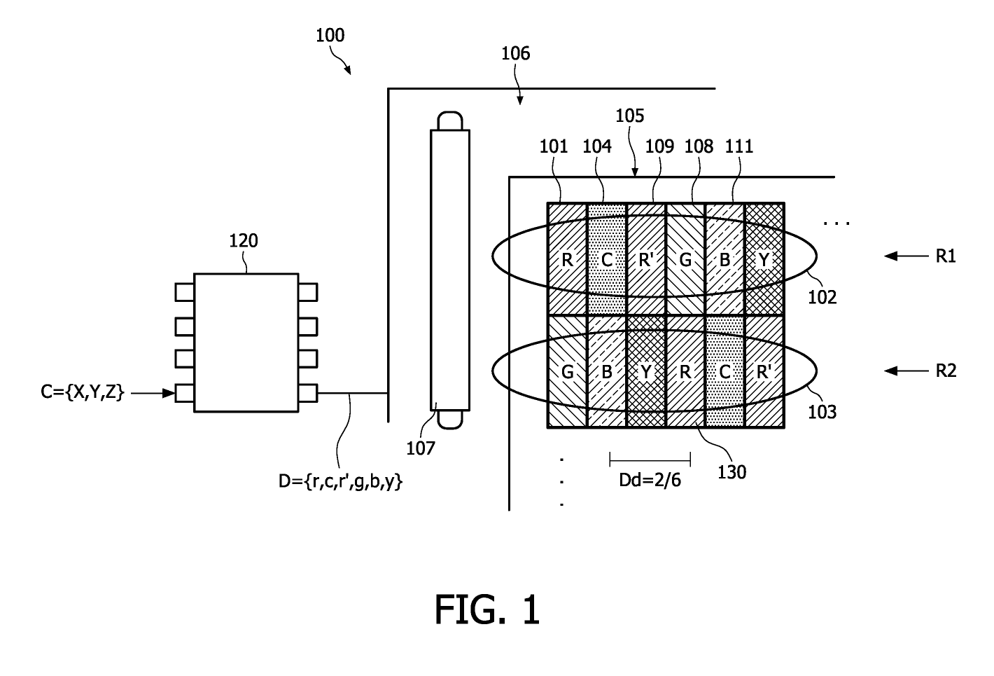

FIG. 1 shows an LCD display 100 with subpixels 101, 104, . . . of a light modulator 105 arranged to modulate the light of a backlight module 106, comprising for example a TL lamp 107 or LED module, to render desired colors.

Some of the subpixels (101, 130) on a grid of the modulator can make red R, which in an LCD typically happens by having an appropriate backlight spectrum multiplied by the transmission curve of a red filter, and a percentage—determined by a red drive value r—of the maximal red output let out under the control of LCD material appropriately actuated by a transistor. The skilled person understands how to build other displays (e.g. plasma, OLED, electronic ink, etc., large or small) and apply our presently described inventive concepts to those.

One could drive an entire pixel 102 (i.e. all the 6 subpixels in a constrained way, together) to make a certain local color, but then the resolution of the display (or the perceived sharpness) would not be very high, since one can make another color only with the next pixel, 6 subpixels further (typically in the horizontal direction where the three dots are shown, the R,C,R′G,B,Y pattern repeats again, for manufacturing simplicity).

However, since one has additional degrees of freedom to render a desired input color C={X,Y,Z} (such a color is typically a triplet, not necessarily in XYZ space, but e.g. YCrCb), one could use this to make a higher resolution picture, by using the RC, R′G duos to approximately render the desired luminance (and not too much color error) [note that the higher resolution rendering is not limited to using duos of subpixels, one can have the algorithm map to e.g. R′GB and BYR, etc.].

Thereto a picture processor 120 may apply algorithms known to the skilled person, e.g. just use the 3× higher resolution picture and convert it to 6 primary driving values D={r,c,r′,g,b,y}, or in addition apply spatial color processing algorithms, e.g. to take into account and minimize residual color errors if one would use such a simple algorithm, by further taking into account the chromatic relationships of the adjacent primaries.

However, it was found by the inventor that rendering such a higher resolution picture works best if the high luminance primaries are on alternate (even or uneven) positions, since by driving those between there maximum (e.g. digital value 255) and minimum (0) one can make larger deviations of local output luminance than with the darker primaries, which contributes to the physical reachable resolution and perceived sharpness.

If the number of primaries is even, than each bright primary subpixel should have two adjacent dark subpixels.

It is advantageous if the one selected of those dark primaries (e.g. for the subpixel to the right of the present high luminance primary subpixel) is of complementary color, at least as far as the not yet selected primaries allows.

Or, more generally, at least it is advantageous if two adjacent colors, or colors of subpixels which are spatially near to each other (e.g. with more than 6 primaries, neighboring bright or dark set subpixels), have a large hue angle between them, so that e.g. a (dark) green is not adjacent to a bright yellowish green, since those primaries comprise the same color components and this may lead to chromatic errors after multiprimary transformation, since at some locations there is a high spatial density of yellowish-greenish colors, and at other locations a lower density, i.e. one wants be able to optimally make all desired colors with high frequency by controlling the driving values of the subpixels.

A complementary color means that the two colors together can form an approximately achromatic color, e.g. the complementary of red is cyan. Those colors are at opposite ends of a line through the white point, so for additive and subtractive triangles, one could form the pairs: red-cyan, green-magenta, and yellow-blue (which together give white).

In this way, apart from setting a local luminance, one can strongly correct local chromatic problems, especially for low saturation pictures/patterns, which often occur in nature.

Another selection according to the possibilities of doing some additional local higher resolution color rendering in addition to the luminance rendering is also possible, e.g. if the display needs to render highly saturated text, or different particular often occurring picture patterns. In case the display needs to render high-resolution high saturated patterns of e.g. an often occurring color (say red), one can use this as an additional principle to further divide the high luminance colors over the subpixels given the main principle of this invention (e.g. Y G Orange C instead of Y G C Orange).

Note that in the exemplary embodiment of FIG. 1, we have shown that there are several patterns possible according to the high luminance primary/low luminance primary interlace concept, and that one could alternate those in the vertical or horizontal direction, but for manufacturing simplicity one may opt for e.g. repeating the pattern of pixel 102 over the entire modulator surface.

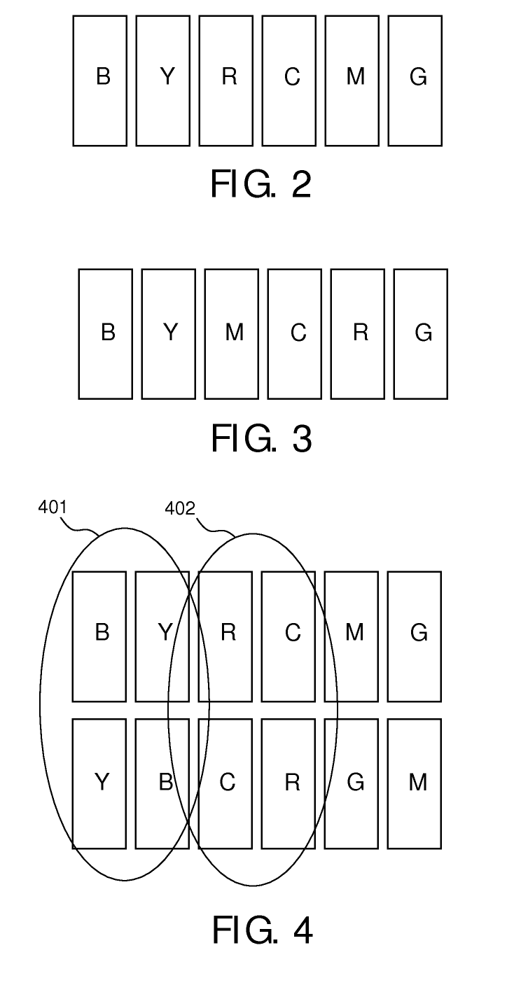

FIG. 2 shows another optimal subpixel distribution of the high/low luminance variation type, with maximal luminance transmissions of e.g. (B, Y, R, C, M, G)=(10, 90, 20, 80, 30, 70).

Again the rationale is on the first hand to at least make the luminance pattern as high frequency as possible, since the eye is more sensitive to luminance patterns (i.e. also errors) than to chromatic patterns. So if one looks at a picture with a luminous background (e.g. white) the residual subpixel structure pattern will be visible only from closer distances to the display than with other suboptimal subpixel structures (e.g. RBGYCM). Secondly, one designs the pattern to have better chromatic properties. When displaying a black and white zone plate picture, both the pixel structure of FIG. 2 and FIG. 3 will give lesser chromatic alias than RBGYCM, but FIG. 2 gives bluish-yellowish chromatic alias rings, whereas FIG. 3 gives desaturated green rings (note that human color vision varies between trichromatic [or polychromatic] to dichromatic or monochromatic depending on viewing distance, these two chromatic patterns will look more similar for larger viewing distances though). So one can still prefer one of the possible patterns based on chromatic rendering capabilities (given the achromatic luminance resolution is already (near) maximized), for typical or particular black and white pictures, and/or specific colors (e.g. the blue of the sky), taking into account the chromatic curves of the human visual system also.

FIG. 3 shows that similar colors can be swapped. Depending on the actual transmission filters, magenta may look relatively similar to the human eye from a distance to red, since both the luminance contribution of the transmitted blue is not too high, and magenta is adjacent to red on the hue circle. So one may notice little difference for many pictures, yet have different aliasing behavior for particular pictures such as the zone plate for other viewing distances. One can calculate approximately what a human eye will see depending on the spectral transmission curves of the primaries, and viewing conditions (in particular spatial distance, which translates to pattern frequency on the cones of the retina), or optimize manually by user preference on approximately chosen test picture sets.

FIG. 4 shows an example on how to tile vertically the optimal preferred subpixel distributions. In this exemplary embodiment, in the second row the complementary colors are swapped. This gives good achromatic behavior on both rows, since blue and yellow are complementary, and there is increased chromatic resolution, since the blues are offsetted in the second row (important for e.g. monochromatic blue picture). However, though being a good pattern, on a somewhat larger scale the pattern is still not the most optimal, since the high/low luminance frequencies are still not perfectly distributed. This gives a higher speckly look for the BY pattern, and a more uniform (grayish) look adjacent on the RCs, which can at certain distances still be seen as a residual artifact.

Another two-dimensional tiling handling this is where one shifts the pattern of FIG. 2 or 3 by 3 subpixels on the adjacent line, creating a double addressable horizontal frequency for that pattern.

The algorithmic components disclosed in this text may in practice be (entirely or in part) realized as hardware (e.g. parts of an application specific IC) or as software running on a special digital signal processor, or a generic processor, etc.

It should be understandable to the skilled person from our presentation which components can be optional improvements and be realized in combination with other components, and how (optional) steps of methods correspond to respective means of apparatuses, and vice versa.

Some of the steps required for the working of the method may be already present in the functionality of the processor instead of described in a computer program product, such as data input and output steps.

It should be noted that the above-mentioned embodiments illustrate rather than limit the invention. Where the skilled person can easily realize a mapping of the presented examples to other regions of the claims, we have for conciseness not in-depth mentioned all these options. Apart from combinations of elements of the invention as combined in the claims, other combinations of the elements are possible. Any combination of elements can be realized in a single dedicated element.

Any reference sign between parentheses in the claim is not intended for limiting the claim. The word “comprising” does not exclude the presence of elements or aspects not listed in a claim. The word “a” or “an” preceding an element does not exclude the presence of a plurality of such elements.

Where we speak of e.g. a blue subpixel, we mean that in the display locally means are applied, such as a filter to filter light from a backlight, or a local excitable phosphor, which generate light of a particular spectrum which to a human has a bluish looking hue.

1. A multiprimary display (100), having more than 3 additive primaries (R,C,G,B), in which that half of the primaries (C,G) having the highest output luminances of the more than 3 additive primaries (R,C,G,B) when a corresponding driving signal (r) for the respective primary is maximal, is generatable by subpixels (104, 108) of the display at approximately equidistant subpixel positions (Dd).

2. A multiprimary display as claimed in claim 1, in which each subpixel (108) usable for generating a primary (G) of the half of the primaries having the highest output luminances, has adjacent subpixels (109, 111) usable for generating other primaries of the more than 3 additive primaries.

3. A multiprimary display as claimed in claim 2, having some primaries which are closer in hue to each other than 360 degrees divided by the number of primaries, e.g. having a first red (R), a cyan (C), a green (G), a second red (R′), a blue (B), and a yellow (Y), in which successively adjacent subpixels (101, 104, 109, 108) of at least one row (R1) of the multiprimary display are usable for generating in the following order: the first red, the cyan, the second red, the green, the blue, and the yellow, or: the green, the blue, the yellow, the first red, the cyan, and the second red.

4. A multiprimary display as claimed in claim 1, in which a subpixel (104) usable for generating one of the primaries (C) of the half of the primaries having the highest output luminances, has at least one of its adjacent subpixels (101) constructed to be usable for generating a primary (R) from the more than 3 additive primaries having a maximally complementary color to the color of the one of the primaries of the half of the primaries having the highest output luminances.

5. A multiprimary display as claimed in claim 1, in which the adjacent subpixels are in successive order a blue (B), a yellow (Y), a red (R), a cyan (C), a magenta (M), and a green (G), or a blue (B), a yellow (Y), a magenta (R), a cyan (C), a red (M), and a green (G).

6. A method of driving a multiprimary display as claimed in claim 1 comprising a step of calculating from an input color (C) a set of driving values for driving the particular subpixels to yield the color (C) {r,c,r′,g,b,y}.
